(19) United States
(12) Patent Application Publication
(10) Pub. No.: US 2024/0281932 A1
(43) Pub. Date: Aug. 22, 2024

(54) IMAGE PROCESSING METHOD AND APPARATUS

(71) Applicant: Beijing Zitiao Network Technology Co., Ltd., Beijing (CN)

(72) Inventor: Xingzhe CHEN, Beijing (CN)

(21) Appl. No.: 18/569,558

(22) PCT Filed: Sep. 6, 2022
(86) PCT No.: PCT/CN2022/117203

§ 371 Date: Dec. 12, 2023

(30) Foreign Application Priority Data
Sep. 10, 2021 (CN) 202111064205.2

(51) Int. Cl. G06T 5/50; G06T 5/40; G06T 7/90; G06V 10/56; G06V 10/80; H04N 1/60

(52) U.S. Cl. CPC G06T 5/50; G06T 5/40; G06T 7/90; G06V 10/56; G06V 10/806; H04N 1/60; G06T 2207/10024; G06T 2207/20208; G06T 2207/20221

(57) ABSTRACT

An image processing method and related apparatuses are provided. The method includes: converting colors of pixels of a foreground image from colors in a first color space of a first color display standard into optical signals under a second color display standard to obtain a first optical signal set; converting colors of pixels of a background image from colors in a second color space of the second color display standard into optical signals under the second color display standard to obtain a second optical signal set; fusing the optical signals in the first optical signal set and the second optical signal set based on a light transmittance of the foreground image to obtain a third optical signal set; and converting optical signals in the third optical signal set into colors in the second color space to obtain a fused image of the foreground image and the background image.

The present application claims priority of Chinese Patent Application No. 202111064205.2, titled “IMAGE PROCESSING METHOD AND APPARATUS” and filed with State Intellectual Property Office of China on Sep. 10, 2021, the entire disclosure of which is incorporated by reference as part of the disclosure of the present application.

### TECHNICAL FIELD

The present disclosure relates to an image processing technology field, especially to an image processing method and apparatus.

### BACKGROUND

When image processing is performed, there is often a need to superpose and fuse a plurality of images to generate a fused image. For example, when a sticker effect is added to an image, an image sticker made in advance needs to be superposed over and fused with the original image to generate a fused image including the sticker effect.

When image superposition and fusion is performed, if a background image and a foreground image are the same in color display standard, the background image and the foreground image may be fused directly based on a preset light transmittance to generate a fused image achieving an expected effect. However, since different color display standards differ in color space, three primary colors, and brightness range, the superposition and fusion of a foreground image under one color display standard with a background image under another color display standard will result in that the color and the like of a fused image do not achieve expected effects. Therefore, images under different color display standards cannot be superposed and fused. For example, when a foreground image is a sticker under a standard dynamic range (SDR) color display standard and a background image is an image under a high dynamic range (HDR) color display standard, since the color space of the SDR color display standard is bt.709, the brightness range is 0 to 100 nit; and the color space of the HDR color display standard is bt.2020 and the brightness range is 0 to 10000 nit. Therefore, if the sticker under the SDR color display standard is directly superposed over and fused with the background image under the HDR color display standard, it may result in the abnormal color of the sticker color region in the fused image, and a pre-designed sticker effect cannot be achieved.

### SUMMARY

In view of the above, embodiments of the present disclosure provide an image processing method and an apparatus, which are used to solve the problem of the abnormal fused image due to superimposing and fusing images under different color display standards.

In order to achieve above purpose, the embodiments of the present disclosure provide following technical solutions.

On the first aspect, embodiments of the present disclosure provide an image processing method, comprising: converting colors of pixels of a foreground image from colors in a first color space of a first color display standard into optical signals under a second color display standard to obtain a first optical signal set; converting colors of pixels of a background image from colors in a second color space of the second color display standard into optical signals under the second color display standard to obtain a second optical signal set; fusing the optical signals in the first optical signal set and the second optical signal set based on a light transmittance of the foreground image to obtain a third optical signal set; and converting optical signals in the third optical signal set into colors in the second color space to obtain a fused image of the foreground image and the background image.

As an alternative implementation of the embodiment of the present disclosure, the converting colors of pixels of a foreground image from colors in a first color space of a first color display standard into optical signals under a second color display standard to obtain a first optical signal set comprises: converting the colors of the pixels of the foreground image into optical signals under the first color display standard based on an electro-optical transfer function of the first color display standard to obtain a fourth optical signal set; and converting the optical signals in the fourth optical signal set into the optical signals under the second color display standard to obtain the first optical signal set.

As an alternative implementation of the embodiment of the present disclosure, the converting colors of pixels of a background image from colors in a second color space of the second color display standard into optical signals under the second color display standard comprises: converting the colors of the pixels of the background image into the optical signals under the second color display standard based on an electro-optical transfer function of the second color display standard.

As an alternative implementation of the embodiment of the present disclosure, the fusing the optical signals in the first optical signal set and the second optical signal set based on a light transmittance of the foreground image to obtain a third optical signal set comprises: performing weighted fusion on optical signals having same pixel coordinates in the first optical signal set and the second optical signal set based on the light transmittance of the foreground image to obtain a fused optical signal set; and generating the third optical signal set according to the fused optical signal set, optical signals having different pixel coordinates from any optical signal in the second optical signal set among the optical signals in the first optical signal set, and optical signals having different pixel coordinates from any optical signal in the first optical signal set among the optical signals in the second optical signal set.

As an alternative implementation of the embodiment of the present disclosure, the performing weighted fusion on the optical signals having same pixel coordinates in the first optical signal set and the second optical signal set based on the light transmittance of the foreground image to obtain a fused optical signal set comprises: obtaining a weight value of a first optical signal in the first optical signal set, wherein the weight value of the first optical signal is a product of the first optical signal and a shading rate of the foreground image, and the shading rate of the foreground image is a difference between 1 and the light transmittance of the foreground image; obtaining a weight value of a second optical signal in the second optical signal set, wherein the first optical signal and the second optical signal have, and the weight value of the second optical signal is a product of the second optical signal and the light transmittance of the foreground image; obtaining a sum of the weight value of the first optical signal and the weight value of the second optical signal as a fusion result of the first optical signal and the second optical signal; and generating the fused optical signal set according to fusion results of the optical signals having the same pixel coordinates in the first optical signal set and the second optical signal set.

As an alternative implementation of the embodiment of the present disclosure, the converting optical signals in the third optical signal set into the colors in the second color space to obtain a fused image of the foreground image and the background image comprises: converting the optical signals in the third optical signal set into the colors in the second color space based on an opto-electrical transfer function of the second color display standard to obtain a first color set; and obtaining the fused image of the foreground image and the background image according to the colors in the first color set and pixel coordinates of the colors in the first color set.

As an alternative implementation of the embodiment of the present disclosure, the converting optical signals in the third optical signal set into the colors in the second color space to obtain a fused image of the foreground image and the background image comprises: converting the optical signals in the third optical signal set into the colors in the second color space based on an opto-electrical transfer function of the second color display standard to obtain a first color set; performing histogram equalization on the colors in the first color set to obtain a second color set; performing weighted mixing on the colors in the first color set and the colors in the second color set based on a preset weight coefficient to obtain a third color set; and obtaining the fused image of the foreground image and the background image according to colors in the third color set and pixel coordinates of the colors in the third color set.

As an alternative implementation of the embodiment of the present disclosure, the performing weighted mixing on the colors in the first color set and the colors in the second color set based on a preset weight coefficient to obtain a third color set comprises: obtaining a weight value of a first color, wherein the first color is a color in the first color set; and the weight value of the first color is a product of the first color and the preset weight coefficient; obtaining a weight value of a second color, wherein the second color is a color having same pixel coordinates with the first color in the second color set; the weight value of the second color is a product of the second color and a weight coefficient difference; and the weight coefficient difference is a difference between 1 and the preset weight coefficient; and obtaining a sum of the weight value of the first color and the weight value of the second color as a weighted mixing result of the first color and the second color.

As an alternative implementation of the embodiment of the present disclosure, the first color display standard is a standard dynamic range (SDR) color display standard; and the second color display standard is a high dynamic range (HDR) color display standard.

On the second aspect, the embodiments of the present disclosure provide an image processing apparatus, comprising: a first conversion unit configured to convert colors of pixels of a foreground image from colors in a first color space of a first color display standard into optical signals under a second color display standard to obtain a first optical signal set; a second conversion unit configured to convert colors of pixels of a background image from colors in a second color space of the second color display standard into optical signals under the second color display standard to obtain a second optical signal set; a fusion unit to fuse the optical signals in the first optical signal set and the second optical signal set based on a light transmittance of the foreground image to obtain a third optical signal set; and an obtaining unit configured to convert optical signals in the third optical signal set into colors in the second color space to obtain a fused image of the foreground image and the background image.

As an alternative implementation of the embodiment of the present disclosure, the first conversion unit is specifically configured to convert the colors of the pixels of the foreground image into optical signals under the first color display standard based on an electro-optical transfer function of the first color display standard to obtain a fourth optical signal set; and convert the optical signals in the fourth optical signal set into the optical signals under the second color display standard to obtain the first optical signal set.

As an alternative implementation of the embodiment of the present disclosure, the second conversion unit is specifically configured to convert the colors of the pixels of the background image into the optical signals under the second color display standard based on an electro-optical transfer function of the second color display standard.

As an alternative implementation of the embodiment of the present disclosure, the fusion unit is specifically configured to perform weighted fusion on the optical signals having same pixel coordinates in the first optical signal set and the second optical signal set based on the light transmittance of the foreground image to obtain a fused optical signal set; and generate the third optical signal set according to the fused optical signal set, optical signals having different pixel coordinates from any optical signal in the second optical signal set among the optical signals in the first optical signal set, and optical signals having different pixel coordinates from any optical signal in the first optical signal set among the optical signals in the second optical signal set.

As an alternative implementation of the embodiment of the present disclosure, the fusion unit is specifically configured to: obtain a weight value of a first optical signal in the first optical signal set, where the weight value of the first optical signal is a product of the first optical signal and a shading rate of the foreground image, and the shading rate of the foreground image is a difference between 1 and the light transmittance of the foreground image; obtain a weight value of a second optical signal in the second optical signal set, where the first optical signal is an optical signal having same pixel coordinates with the second optical signal, and the weight value of the second optical signal is a product of the second optical signal and the light transmittance of the foreground image; obtain a sum of the weight value of the first optical signal and the weight value of the second optical signal as a fusion result of the first optical signal and the second optical signal; and generate the fused optical signal set according to fusion results of the optical signals having the same pixel coordinates in the second optical signal set and the third optical signal set.

As an alternative implementation of the embodiment of the present disclosure, the obtaining unit is specifically configured to convert the optical signals in the third optical signal set into the colors in the second color space based on an opto-electrical transfer function of the second color display standard to obtain a first color set; and obtain the fused image of the foreground image and the background image according to the colors in the first color set and pixel coordinates of the colors in the first color set.

As an alternative implementation of the embodiment of the present disclosure, the obtaining unit is specifically configured to: convert the optical signals in the third optical signal set into the colors in the second color space based on an opto-electrical transfer function of the second color display standard to obtain a first color set; perform histogram equalization on the colors in the first color set to obtain a second color set; perform weighted mixing on the colors in the first color set and the colors in the second color set based on a preset weight coefficient to obtain a third color set; and obtain the fused image of the foreground image and the background image according to the colors in the third color set and pixel coordinates of the colors in the third color set.

As an alternative implementation of the embodiment of the present disclosure, the obtaining unit is specifically configured to obtain a weight value of a first color, where the first color is a color in the first color set; and the weight value of the first color is a product of the first color and the preset weight coefficient; obtain a weight value of a second color, where the second color is a color having same pixel coordinates with the first color in the second color set; the weight value of the second color is a product of the second color and a weight coefficient difference; and the weight coefficient difference is a difference between 1 and the preset weight coefficient; and obtain a sum of the weight value of the first color and the weight value of the second color as a weighted mixing result of the first color and the second color.

As an alternative implementation of the embodiment of the present disclosure, the first color display standard is an SDR color display standard; and the second color display standard is an HDR color display standard.

On the third aspect, the embodiments of the present disclosure provide an electronic device, comprising a memory and a processor, wherein the memory is configured to store a computer program; and the processor is configured to, when executing the computer program, enable the electronic device to implement the image processing method of any one of the above embodiments.

On the fourth aspect, the embodiments of the present disclosure provide a computer-readable storage medium, storing a computer program, wherein the image processing method of any one of the above embodiments is implemented by a computing device when the computer program is executed by the computing device.

On the fifth aspect, the embodiments of the present disclosure provide computer program product, wherein the image processing method of any one of the above embodiments is implemented by a computer when the computer program product is run on the computer.

The image processing method provided in the embodiment of the present disclosure includes: converting colors of pixels of a foreground image from colors in a first color space of a first color display standard into optical signals under a second color display standard to obtain a first optical signal set; converting colors of pixels of a background image from colors in a second color space of the second color display standard into optical signals under the second color display standard to obtain a second optical signal set; fusing the optical signals in the first optical signal set and the second optical signal set based on a light transmittance of the foreground image to obtain a third optical signal set; and converting the optical signals in the third optical signal set into the colors in the second color space to obtain a fused image of the foreground image and the background image. Since the image processing method provided in the embodiment of the present disclosure may convert the colors of the pixels of the foreground image and the colors of the pixels of the background image into the optical signals under the second color display standard before fusion, the image processing method provided in the embodiment of the present disclosure can superpose and fuse the foreground image and the background image in a linear space, avoiding a fused image anomaly caused by the foreground image and the background image conforming with different color display standards. Therefore, the image processing method provided in the embodiment of the present disclosure can solve the problem of fused image anomaly due to superposing and fusing images under different color display standards.

### BRIEF DESCRIPTION OF THE DRAWINGS

The accompanying drawings, which are hereby incorporated in and constitute a part of the present description, illustrate embodiments of the present disclosure, and together with the description, serve to explain the principles of the present disclosure.

To describe the technical solutions in the embodiments of the present disclosure or in the prior art more clearly, the accompanying drawings required in the description of the embodiments or the prior art will be described briefly below. Apparently, other accompanying drawings can also be derived from these drawings by those ordinarily skilled in the art without creative efforts.

FIG. 1 is a first flowchart of an image processing method provided in an embodiment of the present disclosure;

FIG. 2 is a second flowchart of an image processing method provided in an embodiment of the present disclosure;

FIG. 3 is a first schematic diagram of a data flow of an image processing method provided in an embodiment of the present disclosure;

FIG. 4 is a schematic diagram of a positional relationship of a foreground image and a background image provided in an embodiment of the present disclosure;

FIG. 5 is a third flowchart of an image processing method provided in an embodiment of the present disclosure;

FIG. 6 is a second schematic diagram of a data flow of an image processing method provided in an embodiment of the present disclosure;

FIG. 7 is a structural schematic diagram of an image processing apparatus provided in an embodiment of the present disclosure; and

FIG. 8 is a schematic diagram of a hardware structure of an electronic device provided in an embodiment of the present disclosure.

### DETAILED DESCRIPTION

To provide a clearer understanding of the objectives, features, and advantages of the present disclosure, the solutions in the present disclosure will be further described below. It should be noted that the embodiments in the present disclosure and features in the embodiments may be combined with one another without conflict.

Many specific details are described below to help fully understand the present disclosure. However, the present disclosure may also be implemented in other manners different from those described herein. Apparently, the described embodiments in the specification are merely some rather than all of the embodiments of the present disclosure.

In the embodiments of the present disclosure, the words such as “exemplary” or “for example” are intended to represent serving as an example, instance or illustration. Any embodiment or design solution described herein as “exemplary” or “for example” in the embodiments of the present disclosure should not be construed as being more preferred or advantageous over other embodiments or design solutions. Exactly, the words such as “exemplary” or “for example” are intended to present related concepts specifically. Moreover, in the description embodiments of the present disclosure, unless otherwise specified, “a plurality of” means two or more.

A performing agent of the image processing method provided in embodiments of the present disclosure may be an image processing apparatus. The image processing apparatus may be a mobile phone, a Pad, a laptop, a palmtop, a vehicle-mounted terminal, an ultra-mobile personal computer (UMPC), a netbook, a personal digital assistant (PDA), a personal computer (PC), or the like, which will not be particularly limited in the embodiments of the present disclosure.

Self-defined terms in the embodiments of the present disclosure are explained below:

First color display standard: it is defined as a color display standard with which a foreground image complies. The following description is made by taking for example that the first color display standard is a standard dynamic range (SDR) color display standard.

First color space: it is defined as a color space of the first color display standard. When the first color display standard is the SDR color display standard, the first color space is bt.709.

Second color display standard: it is defined as a color display standard with which a background image complies. The following description is made by taking for example that the second color display standard is a high dynamic range (HDR) color display standard.

Second color space: it is defined as a color space of the second color display standard. When the second color display standard is a hybrid log gamma (HLG) color display standard, the second color space is bt.2020.

First optical signal set: it is an optical signal set obtained by converting colors of pixels of a foreground image into optical signals in the second color space. Since the second color space of the HDR color display standard is bt.2020, an optical signal in the first optical signal set is represented by L_{2020sticker}(x,y) below.

Second optical signal set: it is an optical signal set obtained by converting colors of pixels of a background image into optical signals in the second color space. An optical signal in the third optical signal set is represented by L_{2020imgIn}(x,y) below.

Third optical signal set: it is an optical signal set obtained by fusing the optical signals in the first optical signal set and the second optical signal set based on a light transmittance of the foreground image. An optical signal in the third optical signal set is represented by L_{2020imgOut}(x,y) below.

Fourth optical signal set: it is an optical signal set obtained by converting colors of pixels of the foreground image into optical signals in the second color space. Since the color space of the SDR color display standard is bt.709, an optical signal in the fourth optical signal set is represented by L_{709sticker}(x,y) below.

First color set: it is a color set obtained by converting the optical signals in the third optical signal set into the colors in the second color space. A color in the first color set is represented by C_{2020imgOut}(x,y) below.

Second color set: it is a color set obtained by performing histogram equalization on colors in the first color set. A color in the second color set is represented by C_{Dst}(x,y) below.

Third color set: it is a color set obtained by performing weighted mixing on the colors in the first color set and the colors in the second color set. A color in the third color set is represented by C_{DstFinal}(x,y) below.

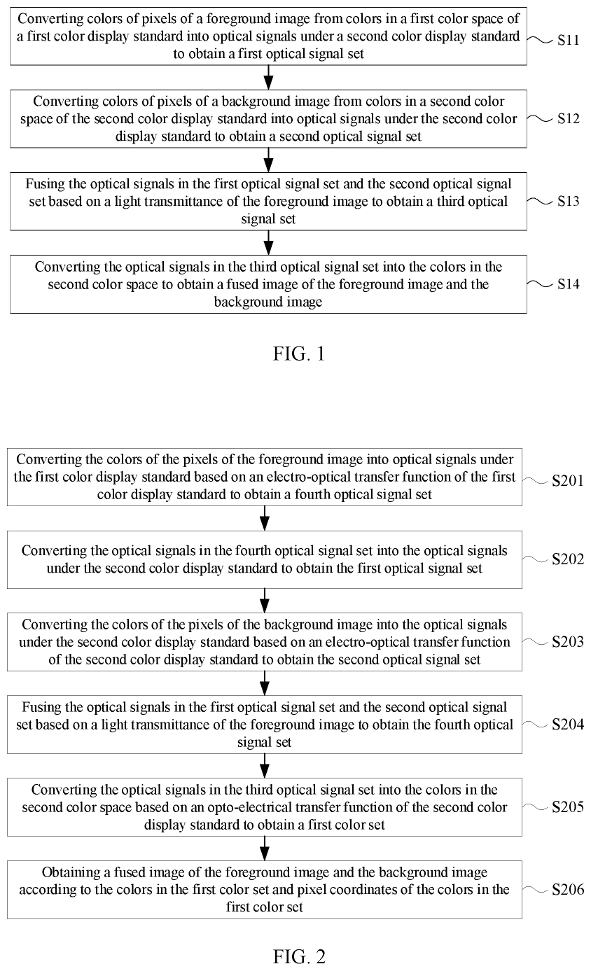

Based on the above contents, an embodiment of the present disclosure provides an image processing method. As shown in FIG. 1, the image processing method includes the following steps S11 to S14.

S11: converting colors of pixels of a foreground image from colors in a first color space of a first color display standard into optical signals under a second color display standard to obtain a first optical signal set.

The foreground image in the embodiment of the present disclosure refers to an image needing to be superposed over and fused with another image. The foreground image may be any image under the first color display standard. The embodiments of the present disclosure have no limitation on the type of the foreground image. Exemplarily, the foreground image may be an image sticker in special effect editing.

Exemplarily, the first color display standard may be an SDR color display standard, and the second color display standard may be an HDR color display standard.

The following embodiments are described by taking for example that the second color display standard is a hybrid log gamma (HLG) color display standard of HDR color display standards. However, the embodiments of the present disclosure are not limited thereto. For example, the second color display standard in the embodiment of the present disclosure may also be a perceptual quantizer (PQ) color display standard of HDR color display standards.

Specifically, the HLG color display standard is an HDR color display standard. The color space of the HLG color display standard is bt.2020, the three primary colors thereof are bt.2020, and an opto-electrical transfer function thereof is under ARIB-STD-b67 standard. Compared with the HDR color display standard, allowable displayed maximum brightness of an SDR color display standard is lower. The color space of the SDR color display standard is color space bt.709, the three primary colors thereof are three primary colors bt.709, and an opto-electrical transfer function thereof is under ITU-RBT.1886 standard.

S12: converting colors of pixels of a background image from colors in a second color space of the second color display standard into optical signals under the second color display standard to obtain a second optical signal set.

Specifically, the background image in the embodiments of the present disclosure refers to an image needing to be set under the foreground image for fusion during superposition and fusion. The background image may be any image under the second color display standard. The embodiments of the present disclosure have no limitation on the type of the background image.

S13: fusing the optical signals in the first optical signal set and the second optical signal set based on a light transmittance of the foreground image to obtain a third optical signal set.

Specifically, the light transmittance of the foreground image may be a light transmittance set by a person editing images as needed or a default light transmittance. Exemplarily, the light transmittance of the foreground image may be 50%.

It needs to be noted that the light transmittance may be the same at each position of the foreground image, or the foreground image may be divided into a plurality of regions and a different light transmittance is set for each region.

Since the optical signals in the second optical signal set and the optical signals in the third optical signal set are all optical signals under the second color display standard, the optical signals in the second optical signal are still the optical signals under the second color display standard.

It also needs to be noted that since a sum of the light transmittance of the foreground image and a shading rate of the foreground image is 1, the light transmittance of the foreground image may also be given in the form of the shading rate. For example, if the shading rate of the foreground image is 80%, the light transmittance of the foreground image is 1-80%=20%.

S14: converting the optical signals in the third optical signal set into the colors in the second color space to obtain a fused image of the foreground image and the background image.

The image processing method provided in the embodiments of the present disclosure includes: converting colors of pixels of a foreground image from colors in a first color space of a first color display standard into optical signals under a second color display standard to obtain a first optical signal set; converting colors of pixels of a background image from colors in a second color space of the second color display standard into optical signals under the second color display standard to obtain a second optical signal set; fusing the optical signals in the first optical signal set and the second optical signal set based on a light transmittance of the foreground image to obtain a third optical signal set; and converting the optical signals in the third optical signal set into the colors in the second color space to obtain a fused image of the foreground image and the background image. Since the image processing method provided in the embodiment of the present disclosure may convert the colors of the pixels of the foreground image and the colors of the pixels of the background image into the optical signals under the second color display standard before fusion, the image processing method provided in the embodiment of the present disclosure can superpose and fuse the foreground image and the background image in a linear space, avoiding a fused image anomaly caused by the foreground image and the background image conforming with different color display standards. Therefore, the image processing method provided in the embodiment of the present disclosure can solve the problem that the superposition and fusion of images under different color display standards will lead to a fused image anomaly.

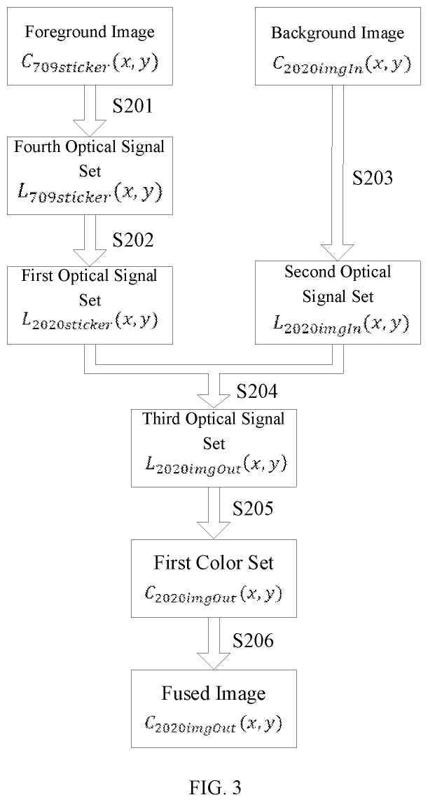

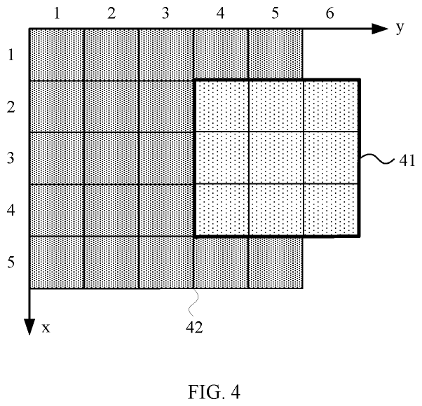

As expansion and subdivision of the foregoing embodiments, the embodiment of the present disclosure further provides another image processing method. With reference to the flowchart shown in FIG. 2 and the schematic diagram of a data flow shown in FIG. 3, the image processing method includes the following steps.

S201: converting the colors of the pixels of the foreground image into optical signals under the first color display standard based on an electro-optical transfer function of the first color display standard to obtain a fourth optical signal set.

Specifically, the electro-optical transfer function of the first color display standard in the embodiment of the present disclosure refers to a function for describing a relationship between a nonlinear color value (a numeric-coded pixel value, an electrical signal) input a display and a linear color value (an optical signal) displayed on the display.

Since a device stores and transmits electrical signals (color values) and different electro-optical transfer functions under different color display standards are different, when the colors (electric signals) of the pixels of the foreground image of the first color display standard are converted into the optical signals in the second color space, the colors of the pixels of the foreground image need to be converted into the optical signals under the first color display standard first to realize conversion of the color values of different color spaces in a linear space.

Exemplarily, step S201 is described below by taking for example that the first color display standard is the SDR color display standard and the first color space is bt.2020.

An opto-electrical transfer function of the SDR color display standard is as follows:

$${L}_{c} = a {\{ max [ ( V + b ) , 0 ] \}}^{γ}$$

$$a = {( {L}_{ω}^{\frac{1}{γ}} - {L}_{b}^{\frac{1}{γ}} )}^{γ}$$

$$b = \frac{{L}_{b}^{\frac{1}{γ}}}{{L}_{ω}^{\frac{1}{γ}} - {L}_{b}^{\frac{1}{γ}}}$$

where V represents an electrical signal under the first color display standard; L_{c} represents an optical signal under the first color display standard; L_{ω} represents an optical signal corresponding to a maximum value of electrical signals; L_{b} represents an optical signal corresponding to a minimum value of electrical signals; and γ is a constant.

Alternatively, the optical signal L_{ω} corresponding to the maximum value of electrical signals and the optical signal L_{b} corresponding to the minimum value of electrical signals may be normalized. That is, letting L_{b}=0 and L_{ω}=1, the optical signals corresponding to other electrical signals are between 0 and 1 in the form of floating points.

The color of each pixel in the foreground image can be converted into an optical signal L_{709sticker}(x,y) under the first color display standard by substituting each of a red component R_{709sticker}(x,y), a green component G_{709sticker}(x,y), and a blue component B_{709sticker}(x,y) of the color C_{709sticker}(x,y) of each pixel in the foreground image as an electrical signal V into the electro-optical transfer function, and the fourth optical signal set can thus be obtained.

S202: converting the optical signals in the fourth optical signal set into the optical signals under the second color display standard to obtain the first optical signal set.

Specifically, each optical signal in the first optical signal set is the optical signal under the first color display standard. Therefore, the optical signals under the first color display standard are converted into the optical signals under the second color display standard by step S202. There may be a particular conversion matrix for the optical signals under different color display standards. By the corresponding conversion matrix, the optical signals under the first color display standard may be converted into the optical signals under the second color display standard.

Exemplarily, when the first color display standard is the SDR color display standard and the second standard is the HLG color display standard, an optical signal under the SDR color display standard is expressed as L_{709sticker}(x,y) and an optical signal under the HLG color display standard obtained by converting L_{709sticker}(x,y) is expressed as L_{2020sticker}(x,y), and the following equation may be established:

$${L}_{2020 s t i c k e r} ( x , y ) = \vert \begin{matrix}0.6274 & 03293 & 00433 \\ 0.0691 & 0.9195 & 0.0114 \\ 0.0164 & 0.0880 & 0.8956\end{matrix} \vert \times {L}_{709 s t i c k e r} ( x , y ) .$$

The optical signals L_{709sticker}(x,y) in the fourth optical signal set are substituted into the above conversion equation one by one so that the optical signals in the fourth optical signal set can be converted into the optical signals L_{2020sticker}(x,y) under the second color display standard, thereby obtaining the first optical signal set.

S203: converting the colors of the pixels of the background image into the optical signals under the second color display standard based on an electro-optical transfer function of the second color display standard to obtain the second optical signal set.

Exemplarily, step S201 is described below by taking for example that the second color display standard is the HLG color display standard.

An opto-electrical transfer function of the HLG color display standard is as follows:

$$V = \{ \begin{matrix}\sqrt{3} * {L}_{c}^{0.5} , & \frac{1}{12} \geq {L}_{c} \geq 0 \\ a * ln ( 12 {L}_{c} - b ) + c , & 1 \geq {L}_{c} > \frac{1}{12}\end{matrix} ,$$

where V represents an electrical signal under the HLG color display standard; L_{c} represents an optical signal under the HLG color display standard; and a, b, and c are all constants: a=0.17883277, b=1-4a=0.28466892, and c=0.5−aln(4a)=0.55991073.

An inverse function of an electro-optical transfer function of the HLG color display standard is obtained so that the electro-optical transfer function of the HLG color display standard can be obtained as:

$${L}_{c} = \{ \begin{matrix}\frac{{V}^{2}}{\sqrt{3}} , & 0 \leq V \leq 0.5 \\ \frac{1}{12} [ exp ( \frac{V - c}{a} ) + b ] , & 0.5 \leq V\end{matrix}$$

Each color C_{2020imgIn}(x,y) in the background image can be converted into an optical signal under the HLG color display standard by substituting a red component R_{2020imgIn}(x,y), a green component G_{2020imgIn}(x,y), and a blue component B_{2020imgIn}(x,y) of each color C_{2020imgIn}(x,y) as an electrical signal V into the electro-optical transfer function, and the second optical signal set can thus be obtained.

S204: fusing the optical signals in the first optical signal set and the second optical signal set based on a light transmittance of the foreground image to obtain the fourth optical signal set.

As an alternative implementation of the embodiment of the present disclosure, step S204 (the optical signals in the first optical signal set and the second optical signal set are fused based on the light transmittance of the foreground image to obtain the fourth optical signal set) may be implemented by: performing weighted fusion on the optical signals having same pixel coordinates in the first optical signal set and the second optical signal set based on the light transmittance of the foreground image to obtain a fused optical signal set; and generating the third optical signal set according to the fused optical signal set, optical signals having different pixel coordinates from any optical signal in the second optical signal set among the optical signals in the first optical signal set, and optical signals having different pixel coordinates from any optical signal in the first optical signal set among the optical signals in the second optical signal set.

Alternatively, generating the third optical signal set according to the fused optical signal set, optical signals having different pixel coordinates from any optical signal in the second optical signal set among the optical signals in the first optical signal set, and optical signals having different pixel coordinates from any optical signal in the first optical signal set among the optical signals in the second optical signal set may be implemented by: adding the optical signals having different pixel coordinates from any optical signal in the second optical signal set among the optical signals in the first optical signal set and the optical signals having different pixel coordinates from any optical signal in the first optical signal set among the optical signals in the second optical signal set to the fused optical signal set to generate the third optical signal set.

Exemplarily, as shown in FIG. 4, the embodiment of the present disclosure is described by taking for example that the background image 41 includes 5*5 pixels and the foreground image 42 includes 3*3 pixels in FIG. 4. The optical signals L_{Typical}(2,4), L_{Typical}(2,5), L_{Typical}(3,4), L_{Typical}(3,5), L_{Typical}(4,4), and L_{Typical}(4,5) in the first optical signal set have same pixel coordinates with the optical signals L_{2020imgIn}(2,4), L_{2020imgIn}(2,5), L_{2020imgIn}(3,4), L_{2020imgIn} (3,5), L_{2020imgIn}(4,4), and L_{2020imgIn}(4,5) in the second optical signal set, respectively. Weighted fusion is performed on L_{Typical}(2,4) and L_{2020imgIn}(2,4), L_{Typical}(2,5) and L_{2020imgIn}(2,5), L_{Typical}(3,4) and L_{2020imgIn}(3,4), L_{Typical} (3,5) and L_{2020imgIn}(3,5), L_{Typical}(4,4) and L_{2020imgIn}(4,4), and L_{Typical}(4,5) and L_{2020imgIn}(4,5) based on the light transmittance of the foreground image to obtain the fused optical signal set {L_{2020imgOut}(2,4), L_{2020imgOut}(2,5), L_{2020imgOut}(3,4), L_{2020imgOut}(3,5), L_{2020imgOut}(4,4), L_{2020imgOut}(4,5)}.

Alternatively, performing weighted fusion on the optical signals having same pixel coordinates in the first optical signal set and the second optical signal set based on the light transmittance of the foreground image to obtain a fused optical signal set includes the following steps a to step d.

Step a: obtaining a weight value of a first optical signal in the first optical signal set.

The weight value of the first optical signal is a product of the first optical signal and a shading rate of the foreground image, and the shading rate of the foreground image is a difference between 1 and the light transmittance of the foreground image.

Letting the weight value of the first optical signal be P_{1_(x,y)} and the light transmittance of the foreground image be q, the weight value of the first optical signal may be obtained by:

$${P}_{1 \_ ( x , y )} = {L}_{Typical} ( x , y ) * ( 1 - q )$$

Step b: obtaining a weight value of a second optical signal in the second optical signal set.

The first optical signal is an optical signal having same pixel coordinates with the second optical signal, and the weight value of the second optical signal is a product of the second optical signal and the light transmittance of the foreground image.

Letting the weight value of the second optical signal be P_{2_(x,y)} and the light transmittance of the foreground image be q, the weight value of the second optical signal may be obtained by:

$${P}_{2 \_ ( x , y )} = {L}_{20 \; 20 imgIn} ( x , y ) * q$$

Step c: obtaining a sum of the weight value of the first optical signal and the weight value of the second optical signal as a fusion result of the first optical signal and the second optical signal.

$${L}_{2020 i m g O u t} ( x , y ) = {L}_{Typical} ( x , y ) * ( 1 - q ) + {L}_{20 \; 20 imgIn} ( x , y ) * q$$

Step d: generating the fused optical signal set according to fusion results of the optical signals having the same pixel coordinates in the first optical signal set and the second optical signal set.

That is, the fusion result of each pair of optical signals having the same pixel coordinates is obtained by step a to step c, and then the fusion results of all the pairs of optical signals having the same pixel coordinates are combined into the fused optical signal set.

Further referring to FIG. 4, the optical signals having different pixel coordinates from any optical signal in the second optical signal set among the optical signals in the first optical signal set include L_{Typical}(2,6), L_{Typical}(3,6), and L_{Typical}(4,6), and the optical signals having different pixel coordinates from any optical signal in the first optical signal set among the optical signals in the second optical signal set include L_{2020imgIn}(1,1), L_{2020imgIn(}1,2), L_{2020imgIn}(1,3), L_{2020imgIn}(1,4), L_{2020imgIn}(1,5), L_{2020imgIn}(2,1), L_{2020imgIn}(2,2), L_{2020imgIn}(2,3), L_{2020imgIn}(3,1), L_{2020imgIn}(3,2), L_{2020imgIn}(3,3), L_{2020imgIn}(4,1), L_{2020imgIn}(4,2), L_{2020imgIn}(4,3), L_{2020imgIn}(5,1), L_{2020imgIn}(5,2), L_{2020imgIn} (5,3), L_{2020imgIn}(5,4), and L_{2020imgIn}(5,5). Therefore, the fourth optical signal set is generated according to the fused optical signal set {L_{2020imgOut}(2,4), L_{2020imgOut} (2,5), L_{2020imgOut}(3,4), L_{2020imgOut}(3,5), L_{2020imgOut}(4,4), L_{2020imgOut}(4,5), L_{Typical}(2,6), L_{Typical}(3,6), L_{Typical}(4,6), L_{2020imgIn}(1,1), L_{2020imgIn}(1,2), L_{2020imgIn}(1,3), L_{2020imgIn}(1,4), L_{2020imgIn}(1,5), L_{2020imgIn}(2,1), L_{2020imgIn} (2,2), L_{2020imgIn}(2,3), L_{2020imgIn}(3,1), L_{2020imgIn}(3,2), L_{2020imgIn}(3,3), L_{2020imgIn}(4,1), L_{2020imgIn}(4,2), L_{2020imgIn}(4,3), L_{2020imgIn}(5,1), L_{2020imgIn} (5,2), L_{2020imgIn}(5,3), L_{2020imgIn}(5,4), L_{2020imgIn}(5,5)}.

Finally, the obtained fourth optical signal set is {L_{2020imgOut}(2,4), L_{2020imgOut}(2,5), L_{2020imgOut}(3,4), L_{2020imgOut}(3,5), L_{2020imgOut}(4,4), L_{2020imgOut}(4,5), L_{2020imgIn}(1,1), L_{2020imgIn}(1,2), L_{2020imgIn}(1,3), L_{2020imgIn} (1,4), L_{2020imgIn}(1,5), L_{2020imgIn}(2,1), L_{2020imgIn}(2,2), L_{2020imgIn}(2,3), L_{2020imgIn}(3,1), L_{2020imgIn}(3,2), L_{2020imgIn}(3,3), L_{2020imgIn}(4,1), L_{2020imgIn} (4,2), L_{2020imgIn}(4,3), L_{2020imgIn}(5,1), L_{2020imgIn}(5,2), L_{2020imgIn}(5,3), L_{2020imgIn}(5,4), L_{2020imgIn}(5,5), L_{Typical}(2,6), L_{Typical}(3,6), L_{Typical}(4,6)}.

S205: converting the optical signals in the third optical signal set into the colors in the second color space based on an opto-electrical transfer function of the second color display standard to obtain a first color set.

In the case that the second color display standard is the HLG color display standard, the conversion relationship between each optical signal in the third optical signal set and a color in the second color space follows the following equation:

An opto-electrical transfer function of the HLG color display standard is as follows:

$$V = \{ \begin{matrix}\sqrt{3} * {L}_{c}^{0.5} , & \frac{1}{12} \geq {L}_{c} \geq 0 \\ a * ln ( 12 {L}_{c} - b ) + c , & 1 \geq {L}_{c} > \frac{1}{12}\end{matrix}$$

where V represents an electrical signal under the HLG color display standard; L_{c} represents an optical signal under the HLG color display standard; and a, b, and c are all constants: a=0.17883277, b=1-4a=0.28466892, and c=0.5−aln(4a)=0.55991073.

Red components, green components, and blue components of the optical signals L_{2020imgOut}(x,y) in the third optical signal set are substituted as L_{c} into the above equation one by one, and the optical signals in the third optical signal set are thus converted into the colors C_{2020imgOut}(x,y) in the second color space, thereby obtaining the first color set.

S206: obtaining a fused image of the foreground image and the background image according to the colors in the first color set and pixel coordinates of the colors in the first color set.

The image processing method provided in the embodiment of the present disclosure includes: converting colors of pixels of a foreground image from colors in a first color space of a first color display standard into optical signals under a second color display standard to obtain a first optical signal set; converting colors of pixels of a background image from colors in a second color space of the second color display standard into optical signals under the second color display standard to obtain a second optical signal set; fusing the optical signals in the first optical signal set and the second optical signal set based on a light transmittance of the foreground image to obtain a third optical signal set; and converting the optical signals in the third optical signal set into the colors in the second color space to obtain a fused image of the foreground image and the background image. Since the image processing method provided in the embodiment of the present disclosure may convert the colors of the pixels of the foreground image and the colors of the pixels of the background image into the optical signals under the second color display standard before fusion, the image processing method provided in the embodiment of the present disclosure can superpose and fuse the foreground image and the background image in a linear space, avoiding a fused image anomaly caused by the foreground image and the background image conforming with different color display standards. Therefore, the image processing method provided in the embodiment of the present disclosure can solve the problem that the superposition and fusion of images under different color display standards will lead to a fused image anomaly.

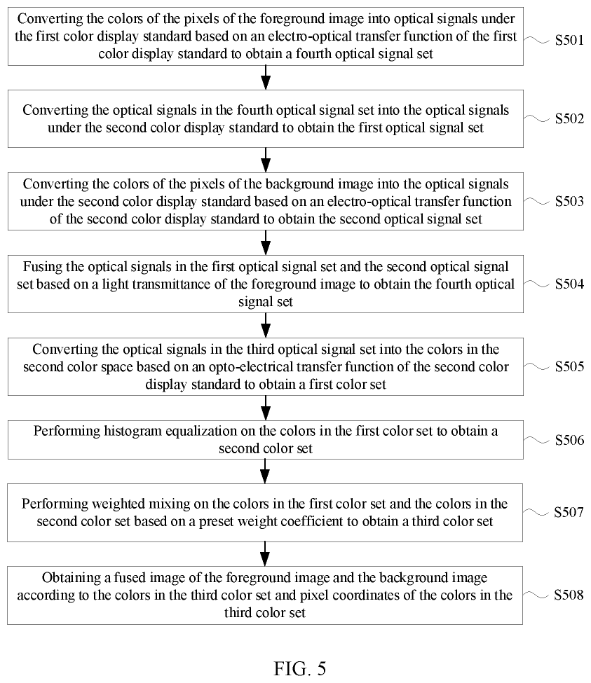

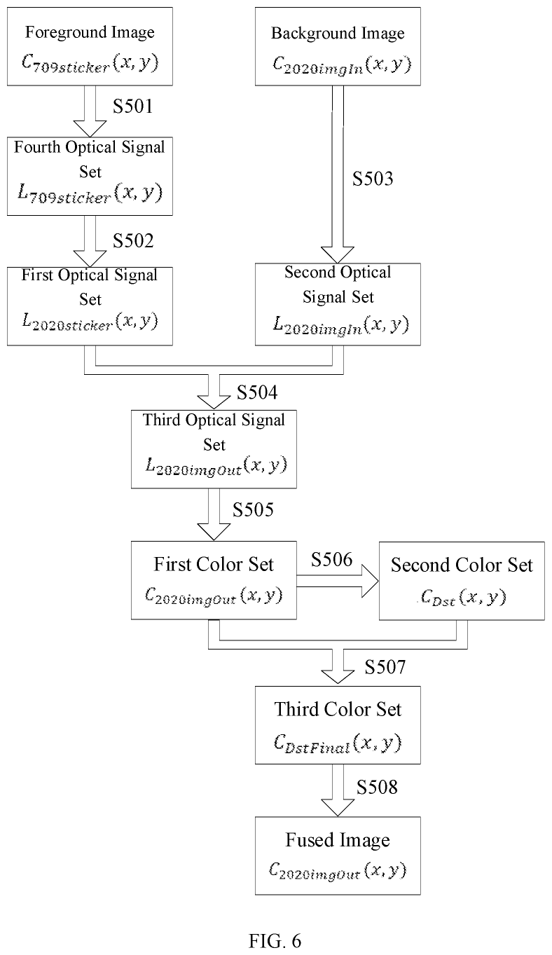

As expansion and subdivision of the foregoing embodiments, an embodiment of the present disclosure further provides another image processing method. With reference to the flowchart shown in FIG. 5 and the schematic diagram of a data flow shown in FIG. 6, the image processing method includes the following steps.

S501: converting the colors of the pixels of the foreground image into optical signals under the first color display standard based on an electro-optical transfer function of the first color display standard to obtain a fourth optical signal set.

S502: converting the optical signals in the fourth optical signal set into the optical signals under the second color display standard to obtain the first optical signal set.

S503: converting the colors of the pixels of the background image into the optical signals under the second color display standard based on an electro-optical transfer function of the second color display standard to obtain the second optical signal set.

S504: fusing the optical signals in the first optical signal set and the second optical signal set based on a light transmittance of the foreground image to obtain the fourth optical signal set.

S505: converting the optical signals in the third optical signal set into the colors in the second color space based on an opto-electrical transfer function of the second color display standard to obtain a first color set.

The implementations of steps S501 to S505 in the embodiment of the present disclosure are similar to the implementations of step S201 to S205 described above. For details, please see the descriptions of steps S201 to S205, which will not be described here redundantly.

S506: performing histogram equalization on the colors in the first color set to obtain a second color set.

Specifically, histogram equalization is a simple and effective image enhancement technique which is intended to change a histogram of an image to change the colors of the pixels in the image, thereby achieving the effect of enhancing the image.

Specifically, an implementation of performing histogram equalization on the colors in the first color set to obtain a second color set may include the following step 1 to step 6.

Step 1: computing a histogram nₖ of the colors in the first color set.

Step 2: obtaining a distribution frequency of each type of color based on a total number of colors in the first color set and a count of each type of color in the histogram nₖ.

Step 3: computing a cumulative distribution frequency sₖ of each type of color in the first color set.

$${s}_{k} = {\sum }_{i = ( 0 , 0 , 0 )}^{k} \frac{{n}_{i}}{N} ,$$

where sₖ represents the cumulative distribution frequency of color k in the first color set; nᵢ represents the distribution frequency of color i; and N represents the total number of the colors in the first color set.

Step 4: normalizing the cumulative distribution frequency sₖ of each type of color in the first color set.

Step 5: obtaining a product of the normalized cumulative distribution frequency sₖ of each color in the first color set and L−1, thereby obtaining the product corresponding to the each color in the first color set.

L represents a count of types of colors in a color space to which the colors in the first color set belong.

Step 6: using an approximate value of the product corresponding to the each color in the first color set as a histogram-equalized color corresponding to the each color in the first color set to obtain the second color set.

S507: performing weighted mixing on the colors in the first color set and the colors in the second color set based on a preset weight coefficient to obtain a third color set.

As an alternative implementation of the embodiment of the present disclosure, step S507 (performing weighted mixing on the colors in the first color set and the colors in the second color set based on a preset weight coefficient to obtain a third color set) includes the following step a to step c.

Step a: obtaining a weight value of a first color.

The first color is a color in the first color set; and the weight value of the first color is a product of the first color and the preset weight coefficient.

Letting the first color be C_{2020imgOut}(x,y), the weight value of the first color be Q_{1_(x,y)}, and the light transmittance of the foreground image be p, the weight value of the first color may be obtained by:

$${Q}_{1 \_ ( x , y )} = {C}_{2020 i m g O u t} ( x , y ) * p$$

Step b: obtaining a weight value of a second color.

The second color is a color having same pixel coordinates with the first color in the second color set; the weight value of the second color is a product of the second color and a weight coefficient difference; and the weight coefficient difference is a difference between 1 and the preset weight coefficient.

Letting the second color be C_{Dst}(x,y), the weight value of the second optical signal be Q_{2_(x,y)}, and the light transmittance of the foreground image be p, the weight value of the second color may be obtained by:

$${Q}_{2 \_ ( x , y )} = {C}_{D s t} ( x , y ) * ( 1 - p )$$

Step c: obtaining a sum of the weight value of the first color and the weight value of the second color as a weighted mixing result of the first color and the second color.

Letting the weighted mixing result of the first color and the second color be C_{DstFinal}(x,y), the following equation may be established:

$${c}_{D s t F i n a i ( x , y ) = {C}_{2020 i m g O u t} ( x , y ) *} P + {C}_{D s t} ( x , y ) * ( 1 - p )$$

S508: obtaining a fused image of the foreground image and the background image according to the colors in the third color set and pixel coordinates of the colors in the third color set.

On the basis of the foregoing embodiments, according to the image processing method provided in the embodiments of the present disclosure, after the first color set is obtained, histogram equalization may be further performed on the colors in the first color set to obtain the second color set; weighted mixing is performed on the colors in the first color set and the color in the second color set based on the preset weight coefficient to obtain the third color set; and then the fused image of the foreground image and the background image is obtained based on the colors in the third color set and the pixel coordinates of the colors in the third color set. Therefore, the image processing method provided in the embodiments of the present disclosure can superpose and fuse the foreground image and the background image in a linear space and can compensate the lost image progress during color control conversion, therefore, the image processing method provided in the embodiments of the present disclosure can further avoid a fused image anomaly caused by the foreground image and the background image conforming with different color display standards.

Based on the same inventive concept, as an implementation of the image processing method, an embodiment of the present disclosure further provides an image processing apparatus. The apparatus embodiments correspond to the foregoing method embodiments. For ease of reading, the apparatus embodiments do not present the details in the foregoing method embodiments. However, it will be clear that the image processing apparatus in the present embodiment can correspond to all the contents in the foregoing method embodiments.

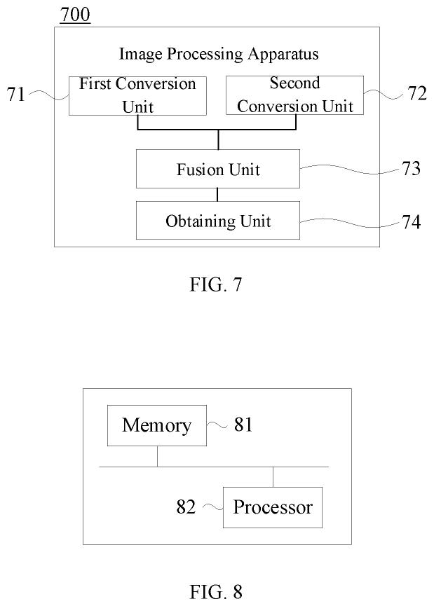

An embodiment of the present disclosure provides an image processing apparatus. FIG. 7 is a structural schematic diagram of the image processing apparatus. As shown in FIG. 7, the image processing apparatus 700 includes: a first conversion unit 71 configured to convert colors of pixels of a foreground image from colors in a first color space of a first color display standard into optical signals under a second color display standard to obtain a first optical signal set; a second conversion unit 72 configured to convert colors of pixels of a background image from colors in a second color space of the second color display standard into optical signals under the second color display standard to obtain a second optical signal set; a fusion unit 73 to fuse the optical signals in the first optical signal set and the second optical signal set based on a light transmittance of the foreground image to obtain a third optical signal set; and an obtaining unit 74 configured to convert the optical signals in the third optical signal set into the colors in the second color space to obtain a fused image of the foreground image and the background image.

As an alternative implementation of the embodiment of the present disclosure, the first conversion unit 71 may be configured to: convert the colors of the pixels of the foreground image into optical signals under the first color display standard based on an electro-optical transfer function of the first color display standard to obtain a fourth optical signal set; and convert the optical signals in the fourth optical signal set into the optical signals under the second color display standard to obtain the first optical signal set.

As an alternative implementation of the embodiment of the present disclosure, the second conversion unit 72 may be configured to: convert the colors of the pixels of the background image into the optical signals under the second color display standard based on an electro-optical transfer function of the second color display standard.

As an alternative implementation of the embodiment of the present disclosure, the fusion unit 73 may be configured to: perform weighted fusion on the optical signals having same pixel coordinates in the first optical signal set and the second optical signal set based on the light transmittance of the foreground image to obtain a fused optical signal set; and generate the third optical signal set according to the fused optical signal set, optical signals having different pixel coordinates from any optical signal in the second optical signal set among the optical signals in the first optical signal set, and optical signals having different pixel coordinates from any optical signal in the first optical signal set among the optical signals in the second optical signal set.

As an alternative implementation of the embodiment of the present disclosure, the fusion unit 73 may be configured to: obtain a weight value of a first optical signal in the first optical signal set, where the weight value of the first optical signal is a product of the first optical signal and a shading rate of the foreground image, and the shading rate of the foreground image is a difference between 1 and the light transmittance of the foreground image; obtain a weight value of a second optical signal in the second optical signal set, where the first optical signal is an optical signal having same pixel coordinates with the second optical signal, and the weight value of the second optical signal is a product of the second optical signal and the light transmittance of the foreground image; obtain a sum of the weight value of the first optical signal and the weight value of the second optical signal as a fusion result of the first optical signal and the second optical signal; and generate the fused optical signal set according to fusion results of the optical signals having the same pixel coordinates in the second optical signal set and the third optical signal set.

As an alternative implementation of the embodiment of the present disclosure, the obtaining unit 74 may be configured to: convert the optical signals in the third optical signal set into the colors in the second color space based on an opto-electrical transfer function of the second color display standard to obtain a first color set; and obtain the fused image of the foreground image and the background image according to the colors in the first color set and pixel coordinates of the colors in the first color set.

As an alternative implementation of the embodiment of the present disclosure, the obtaining unit 74 may be configured to: convert the optical signals in the third optical signal set into the colors in the second color space based on an opto-electrical transfer function of the second color display standard to obtain a first color set; perform histogram equalization on the colors in the first color set to obtain a second color set; perform weighted mixing on the colors in the first color set and the colors in the second color set based on a preset weight coefficient to obtain a third color set; and obtain the fused image of the foreground image and the background image according to the colors in the third color set and pixel coordinates of the colors in the third color set.

As an alternative implementation of the embodiment of the present disclosure, the obtaining unit 74 may be configured to: obtain a weight value of a first color, where the first color is a color in the first color set; and the weight value of the first color is a product of the first color and the preset weight coefficient; obtain a weight value of a second color, where the second color is a color having same pixel coordinates with the first color in the second color set; the weight value of the second color is a product of the second color and a weight coefficient difference; and the weight coefficient difference is a difference between 1 and the preset weight coefficient; and obtain a sum of the weight value of the first color and the weight value of the second color as a weighted mixing result of the first color and the second color.

As an alternative implementation of the embodiment of the present disclosure, the first color display standard is an SDR color display standard; and the second color display standard is an HDR color display standard.

The image processing apparatus provided in the present embodiment can perform the image processing method provided in the foregoing method embodiments, and the implementation principles and technical effects are similar, which will not be described herein.

Based on the same inventive concept, an embodiment of the present disclosure further provides an electronic device. FIG. 8 is a schematic diagram of an electronic device provided in an embodiment of the present disclosure. As shown in FIG. 8, the electronic device provided in the present embodiment includes a memory and 81 a processor 82, where the memory 81 is configured to store a computer program; and the processor 82 is configured to, when executing the computer program, cause the electronic device to implement the image processing method provided in the foregoing embodiments.

An embodiment of the present disclosure further provides a computer-readable storage medium. A computer program is stored on the computer-readable storage medium, and when the computer program is executed by a computing device, the image processing method provided in the foregoing embodiments is implemented by the computing device.

An embodiment of the present disclosure further provides a computer program product and when the computer program product is run on a computer, the image processing method provided in the foregoing embodiments is implemented by the computer.

Those skilled in the art will understand that the embodiments of the present disclosure may be provided as a method, a system, or a computer program product. Therefore, the embodiments of the present disclosure may take the form of hardware only embodiments, software only embodiments, or embodiments with a combination of software and hardware. Moreover, the embodiments of the present disclosure may take the form of a computer program product that is implemented on one or more computer-usable storage media that include computer-usable program code.

The processor may be a central processing unit (CPU), and may also be other general-purpose processor, a digital signal processor (DSP), an application specific integrated circuit (ASIC), a field-programmable gate array (FPGA) or other programmable logic device, a discrete gate, a transistor logic device, a discrete hardware component, etc. The general-purpose processor may be a microprocessor, or the processor may be any conventional processor, etc.

The memory may include a non-permanent memory in a computer-readable medium and may take the form of a random access memory (RAM) and/or a non-volatile memory, such as a read only memory (ROM) or a flash RAM. The memory is an example of the computer-readable medium.

The computer-readable medium includes permanent and non-permanent, removable and non-removable storage mediums. The storage medium may realize information storage by any method or technique. The information may be computer-readable instructions, data structures, program modules, or other data. Examples of the storage medium of the computer include but are not limited to a phase-change RAM (PRAM), a static random access memory (SRAM), a dynamic random access memory (DRAM), other types of RAMs and ROMs, an electrically erasable programmable read-only memory (EEPROM), a flash memory or other memory techniques, a compact disk read-only memory (CD-ROM), a digital versatile disc (DVD), or other optical storage, a cassette type magnetic tape, disk storage, or other magnetic storage device, or other non-transmission medium, that can be used to store information accessible by computing devices. According to the definitions herein, the computer-readable medium does not include transitory computer-readable media, such as modulated data signals and carriers.

Finally, it should be noted that the foregoing embodiments are merely intended to describe rather than limit the technical solutions of the embodiments of the present disclosure. Although the embodiments of the present disclosure are described in detail with reference to the foregoing embodiments, those of ordinary skill in the art should understand that they can still modify the technical solutions described in the foregoing embodiments, or make equivalent replacements to some technical features therein. These modifications or replacements do not cause the essence of the corresponding technical solutions to deviate from the scope of the technical solutions of the embodiments of the present disclosure.

1. An image processing method, comprising:
converting colors of pixels of a foreground image from colors in a first color space of a first color display standard into optical signals under a second color display standard to obtain a first optical signal set;
converting colors of pixels of a background image from colors in a second color space of the second color display standard into optical signals under the second color display standard to obtain a second optical signal set;
fusing the optical signals in the first optical signal set and the second optical signal set based on a light transmittance of the foreground image to obtain a third optical signal set; and
converting optical signals in the third optical signal set into colors in the second color space to obtain a fused image of the foreground image and the background image.

2. The image processing method according to claim 1, wherein the converting colors of pixels of a foreground image from colors in a first color space of a first color display standard into optical signals under a second color display standard to obtain a first optical signal set comprises:
converting the colors of the pixels of the foreground image into optical signals under the first color display standard based on an electro-optical transfer function of the first color display standard to obtain a fourth optical signal set; and
converting the optical signals in the fourth optical signal set into the optical signals under the second color display standard to obtain the first optical signal set.

3. The image processing method according to claim 1, wherein the converting colors of pixels of a background image from colors in a second color space of the second color display standard into optical signals under the second color display standard comprises:
converting the colors of the pixels of the background image into the optical signals under the second color display standard based on an electro-optical transfer function of the second color display standard.

4. The image processing method according to claim 1, wherein the fusing the optical signals in the first optical signal set and the second optical signal set based on a light transmittance of the foreground image to obtain a third optical signal set comprises:
performing weighted fusion on optical signals having same pixel coordinates in the first optical signal set and the second optical signal set based on the light transmittance of the foreground image to obtain a fused optical signal set; and
generating the third optical signal set according to the fused optical signal set, optical signals having different pixel coordinates from any optical signal in the second optical signal set among the optical signals in the first optical signal set, and optical signals having different pixel coordinates from any optical signal in the first optical signal set among the optical signals in the second optical signal set.

5. The image processing method according to claim 4, wherein the performing weighted fusion on the optical signals having same pixel coordinates in the first optical signal set and the second optical signal set based on the light transmittance of the foreground image to obtain a fused optical signal set comprises:
obtaining a weight value of a first optical signal in the first optical signal set, wherein the weight value of the first optical signal is a product of the first optical signal and a shading rate of the foreground image, and the shading rate of the foreground image is a difference between 1 and the light transmittance of the foreground image;
obtaining a weight value of a second optical signal in the second optical signal set, wherein the first optical signal and the second optical signal have, and the weight value of the second optical signal is a product of the second optical signal and the light transmittance of the foreground image;
obtaining a sum of the weight value of the first optical signal and the weight value of the second optical signal as a fusion result of the first optical signal and the second optical signal; and
generating the fused optical signal set according to fusion results of the optical signals having the same pixel coordinates in the first optical signal set and the second optical signal set.

6. The image processing method according to claim 1, wherein the converting optical signals in the third optical signal set into the colors in the second color space to obtain a fused image of the foreground image and the background image comprises:
converting the optical signals in the third optical signal set into the colors in the second color space based on an opto-electrical transfer function of the second color display standard to obtain a first color set; and
obtaining the fused image of the foreground image and the background image according to the colors in the first color set and pixel coordinates of the colors in the first color set.

7. The image processing method according to claim 1, wherein the converting optical signals in the third optical signal set into the colors in the second color space to obtain a fused image of the foreground image and the background image comprises:
converting the optical signals in the third optical signal set into the colors in the second color space based on an opto-electrical transfer function of the second color display standard to obtain a first color set;
performing histogram equalization on the colors in the first color set to obtain a second color set;
performing weighted mixing on the colors in the first color set and the colors in the second color set based on a preset weight coefficient to obtain a third color set; and
obtaining the fused image of the foreground image and the background image according to colors in the third color set and pixel coordinates of the colors in the third color set.

8. The image processing method according to claim 7, wherein the performing weighted mixing on the colors in the first color set and the colors in the second color set based on a preset weight coefficient to obtain a third color set comprises:
obtaining a weight value of a first color, wherein the first color is a color in the first color set; and the weight value of the first color is a product of the first color and the preset weight coefficient;
obtaining a weight value of a second color, wherein the second color is a color having same pixel coordinates with the first color in the second color set; the weight value of the second color is a product of the second color and a weight coefficient difference; and the weight coefficient difference is a difference between 1 and the preset weight coefficient; and
obtaining a sum of the weight value of the first color and the weight value of the second color as a weighted mixing result of the first color and the second color.

9. The image processing method according to claim 1, wherein
the first color display standard is a standard dynamic range (SDR) color display standard; and
the second color display standard is a high dynamic range (HDR) color display standard.

10. An image processing apparatus, comprising:
a first conversion unit configured to convert colors of pixels of a foreground image from colors in a first color space of a first color display standard into optical signals under a second color display standard to obtain a first optical signal set;
a second conversion unit configured to convert colors of pixels of a background image from colors in a second color space of the second color display standard into optical signals under the second color display standard to obtain a second optical signal set;
a fusion unit to fuse the optical signals in the first optical signal set and the second optical signal set based on a light transmittance of the foreground image to obtain a third optical signal set; and
an obtaining unit configured to convert optical signals in the third optical signal set into colors in the second color space to obtain a fused image of the foreground image and the background image.

11. An electronic device, comprising a memory and a processor, wherein the memory is configured to store a computer program; and the processor is configured to, when executing the computer program, enable the electronic device to implement an image processing method comprising:
converting colors of pixels of a foreground image from colors in a first color space of a first color display standard into optical signals under a second color display standard to obtain a first optical signal set;
converting colors of pixels of a background image from colors in a second color space of the second color display standard into optical signals under the second color display standard to obtain a second optical signal set;
fusing the optical signals in the first optical signal set and the second optical signal set based on a light transmittance of the foreground image to obtain a third optical signal set; and
converting optical signals in the third optical signal set into colors in the second color space to obtain a fused image of the foreground image and the background image.

12. A computer-readable storage medium, storing a computer program, wherein the image processing method according to claim 1 is implemented by a computing device when the computer program is executed by the computing device.

13. A computer program product, wherein the image processing method according to claim 1 is implemented by a computer when the computer program product is run on the computer.

14. The electronic device according to claim 11, wherein the converting colors of pixels of a foreground image from colors in a first color space of a first color display standard into optical signals under a second color display standard to obtain a first optical signal set comprises:
converting the colors of the pixels of the foreground image into optical signals under the first color display standard based on an electro-optical transfer function of the first color display standard to obtain a fourth optical signal set; and
converting the optical signals in the fourth optical signal set into the optical signals under the second color display standard to obtain the first optical signal set.

15. The electronic device according to claim 11, wherein the converting colors of pixels of a background image from colors in a second color space of the second color display standard into optical signals under the second color display standard comprises:
converting the colors of the pixels of the background image into the optical signals under the second color display standard based on an electro-optical transfer function of the second color display standard.

16. The electronic device according to claim 11, wherein the fusing the optical signals in the first optical signal set and the second optical signal set based on a light transmittance of the foreground image to obtain a third optical signal set comprises:
performing weighted fusion on optical signals having same pixel coordinates in the first optical signal set and the second optical signal set based on the light transmittance of the foreground image to obtain a fused optical signal set; and
generating the third optical signal set according to the fused optical signal set, optical signals having different pixel coordinates from any optical signal in the second optical signal set among the optical signals in the first optical signal set, and optical signals having different pixel coordinates from any optical signal in the first optical signal set among the optical signals in the second optical signal set.

17. The electronic device according to claim 16, wherein the performing weighted fusion on the optical signals having same pixel coordinates in the first optical signal set and the second optical signal set based on the light transmittance of the foreground image to obtain a fused optical signal set comprises:
obtaining a weight value of a first optical signal in the first optical signal set, wherein the weight value of the first optical signal is a product of the first optical signal and a shading rate of the foreground image, and the shading rate of the foreground image is a difference between 1 and the light transmittance of the foreground image;
obtaining a weight value of a second optical signal in the second optical signal set, wherein the first optical signal and the second optical signal have, and the weight value of the second optical signal is a product of the second optical signal and the light transmittance of the foreground image;
obtaining a sum of the weight value of the first optical signal and the weight value of the second optical signal as a fusion result of the first optical signal and the second optical signal; and
generating the fused optical signal set according to fusion results of the optical signals having the same pixel coordinates in the first optical signal set and the second optical signal set.

18. The electronic device according to claim 11, wherein the converting optical signals in the third optical signal set into the colors in the second color space to obtain a fused image of the foreground image and the background image comprises:
converting the optical signals in the third optical signal set into the colors in the second color space based on an opto-electrical transfer function of the second color display standard to obtain a first color set; and
obtaining the fused image of the foreground image and the background image according to the colors in the first color set and pixel coordinates of the colors in the first color set.

19. The electronic device according to claim 11, wherein the converting optical signals in the third optical signal set into the colors in the second color space to obtain a fused image of the foreground image and the background image comprises:
converting the optical signals in the third optical signal set into the colors in the second color space based on an opto-electrical transfer function of the second color display standard to obtain a first color set;
performing histogram equalization on the colors in the first color set to obtain a second color set;
performing weighted mixing on the colors in the first color set and the colors in the second color set based on a preset weight coefficient to obtain a third color set; and
obtaining the fused image of the foreground image and the background image according to colors in the third color set and pixel coordinates of the colors in the third color set.

20. The electronic device according to claim 19, wherein the performing weighted mixing on the colors in the first color set and the colors in the second color set based on a preset weight coefficient to obtain a third color set comprises:
obtaining a weight value of a first color, wherein the first color is a color in the first color set; and the weight value of the first color is a product of the first color and the preset weight coefficient;
obtaining a weight value of a second color, wherein the second color is a color having same pixel coordinates with the first color in the second color set; the weight value of the second color is a product of the second color and a weight coefficient difference; and the weight coefficient difference is a difference between 1 and the preset weight coefficient; and
obtaining a sum of the weight value of the first color and the weight value of the second color as a weighted mixing result of the first color and the second color.
